(19) United States
(12) Patent Application Publication
(10) Pub. No.: US 2017/0344432 A1
(43) Pub. Date: Nov. 30, 2017

(54) DATA SYNCHRONIZATION METHOD AND DEVICE WITHOUT REDUNDANT REPLICATION

(71) Applicant: QNAP SYSTEMS, INC., New Taipei City (TW)

(72) Inventors: Chih-Hung Wu, New Taipei City (TW); Chien-Hsiung Tai, New Taipei City (TW)

(73) Assignee: QNAP SYSTEMS, INC., New Taipei City (TW)

(21) Appl. No.: 15/216,688

(22) Filed: Jul. 21, 2016

(30) Foreign Application Priority Data
May 31, 2016 (TW) 105116981

(51) Int. Cl. G06F 11/14; G06F 17/30

(52) U.S. Cl. CPC G06F 11/1451; G06F 17/30598; G06F 17/30371; G06F 17/30575; G06F 2201/80

(57) ABSTRACT

Data synchronization method and device without redundant replication are used for providing real-time data accessing service and synchronizing valid data stored in a target storage apparatus to a backup storage apparatus at the same time. The target storage apparatus checks update statuses of the valid data. The valid data of the target storage apparatus is at least classified into a cold data group and a hot data group in accordance with the update statuses. In a first synchronization period, based on address information of the data block without valid data in the target storage apparatus, the data block without valid data is correspondingly established in the backup storage apparatus. At the first synchronization period, the valid data in the cold data group are synchronized from the target storage apparatus to the backup storage apparatus, and the valid data in the hot data group are not synchronized.

### CROSS-REFERENCE TO RELATED APPLICATION

This application claims the priority benefit of Taiwan application serial no. 105116981, filed on May 31, 2016. The entirety of the above-mentioned patent application is hereby incorporated by reference herein and made a part of this specification.

### BACKGROUND OF THE INVENTION

### 1. Field of the Invention

The invention relates to a data backup technique, and particularly relates to a data synchronization method and device without redundant data replication.

### 2. Description of Related Art

In a communication network of computers, it is common to replicate/synchronize data stored in one storage apparatus (referred to as target storage apparatus) to another storage apparatus (referred to as backup storage apparatus) to avoid unexpected loss of data. During a process of replicating contents in the target storage apparatus to the backup storage apparatus via a network with a limited bandwidth at the same time when providing real-time data access services, a throughput of data synchronization of the target storage apparatus is affected by the network bandwidth and an accessing capability of a disk itself.

In a conventional data synchronization method, all the contents in all the data blocks in a storage device of the target storage apparatus are replicated to a storage device of the backup storage apparatus in a first data replication/synchronization period, regardless of whether the replicated contents are valid data. Thus, it is expected that the limited network bandwidth is wasted when the invalid data of the target storage apparatus are replicated to the backup storage apparatus. In addition, an efficiency of the first data replication/synchronization period is reduced.

Besides, according to the conventional data synchronization method, all the contents in all the data blocks in the storage device of the target storage apparatus are replicated to the storage device of the backup storage apparatus in the first data replication/synchronization period, regardless of whether the replicated data are cold data (also referred to as seldom accessed data) or hot data (also referred to as frequently accessed data). Here, the term “hot data” refers to data that are frequently accessed/modified recently. For example, assuming that an access operation is performed to a data block of the target storage apparatus in a service procedure, the data in the data block are hot data before the data block are closed by the service procedure (i.e., the access operation is completed) or the service procedure is closed. Thus, it is expected that replicating the hot data in a data block of the target storage apparatus to the backup storage apparatus during the first data replication/synchronization period may result in redundancy in data replication, because the hot data in the data block need to be synchronized/replicated to the backup storage apparatus again when the hot data in the data block are modified again. Repetitively replicating the hot data of the same data block to the backup storage apparatus may result in waste of the limited network bandwidth and reduction of the data replication/synchronization efficiency.

### SUMMARY OF THE INVENTION

The invention provides a data synchronization method and device without redundant data that save redundant data replication to a backup storage apparatus to improve an efficiency of a first data replication/synchronization period.

An embodiment of the invention provides a data synchronization method without redundant data replication. The method is adapted to synchronize a plurality of valid data stored in a target storage apparatus to a backup storage apparatus at the same time when providing real-time data access service. The data synchronization method includes: checking update statuses of the valid data stored in the target storage apparatus; classifying the valid data at least into a cold data group and a hot data group based on the update statuses of the valid data; during a first synchronization period, correspondingly establishing data blocks without valid data in a plurality of data blocks of a storage device of the backup storage apparatus based on address information of at least one data block without valid data (also referred to as unallocated space) in a plurality of data blocks of a storage device of the target storage apparatus; and during the first synchronization period, synchronizing the valid data in the cold data group from the storage device of the target storage apparatus to the storage device of the backup storage apparatus, and not synchronizing the valid data in the hot data group from the storage device of the target storage apparatus to the storage device of the backup storage apparatus.

An embodiment of the invention provides a data synchronization device without redundant data replication. The data synchronization device includes a target storage apparatus and a backup storage apparatus. The target storage apparatus includes a replicate device and a storage device. The replicate device of the target storage apparatus is coupled to the storage device of the target storage apparatus. The replicate device of the target storage apparatus checks update statuses of a plurality of valid data stored in the storage device of the target storage apparatus. The replicate device of the target storage apparatus classifies the valid data at least into a cold data group and a hot data group based on the update statuses of the valid data. The backup storage apparatus is coupled to the target storage apparatus. The backup storage includes a replicate device and a storage device. The replicate device of the backup storage apparatus is coupled to the storage device of the backup storage apparatus. The replicate device of the backup storage apparatus correspondingly establishes data blocks without valid data in a plurality of data blocks of the storage device of the backup storage apparatus based on address information of at least one data block without valid data in a plurality of data blocks of the storage device of the target storage apparatus in a first synchronization period. The replicate device of the backup storage apparatus synchronizes the valid data in the cold data group from the storage device of the target storage apparatus to the storage device of the backup storage apparatus and does not synchronize the valid data in the hot data group from the storage device of the target storage apparatus to the storage device of the backup storage apparatus in the first synchronization period.

Based on the above, the data synchronization method and device without redundant data replication according to the embodiments of the invention classify the valid data stored in the target storage apparatus at least into the cold data group and the hot data group. During the first synchronization period, the valid data in the cold data group in the target storage apparatus are synchronized to the backup storage apparatus, and the valid data in the hot data group in the target storage apparatus are not synchronized to the backup storage apparatus. For the blocks without valid data, the packet without payload having the address information of the data blocks is transmitted to the backup storage apparatus. Thus, the data synchronization method and device without redundant data replication according to the embodiments of the invention are able to save the redundant data replication to the backup storage apparatus during the first synchronization period, so as to improve the efficiency of the first synchronization period.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block view illustrating a data synchronization device without redundant data replication according to an embodiment of the invention.

FIG. 2 is a flowchart illustrating a data synchronization method without redundant data replication according to an embodiment of the invention.

FIG. 3 is a schematic view illustrating a scenario where a target storage apparatus transmits a packet without payload to a backup storage apparatus when Steps S210 and S215 in FIG. 2 are performed.

FIG. 4 is a schematic view illustrating a scenario where the target storage apparatus transmits valid data of a cold data group to the backup storage apparatus when Steps S220 and S225 in FIG. 2 are performed.

FIG. 5 is a schematic view illustrating a scenario where the target storage apparatus transmits valid data of a hot data group to the backup storage apparatus when Steps S245 and S250 of FIG. 2 are performed.

FIG. 6 is a flowchart illustrating a data synchronization method without redundant data replication according to another embodiment of the invention.

FIG. 7 is a flowchart illustrating a data synchronization method without redundant data replication according to still another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Throughout the specification (including claims) of the invention, the term “couple” (or “connect”) may refer to any direct or indirect connection means. For example, if it is described that a first device is coupled (or connected) to a second device, it shall be interpreted that the first device may be directly connected to the second device, or the first device may be indirectly connected to the second device through another device or by a connection means. Moreover, elements/components/steps with same reference numerals represent same or similar parts in the drawings and embodiments. Descriptions related to elements/components/steps referred to with same reference numerals or described with same terms in different embodiments may be referred to each other.

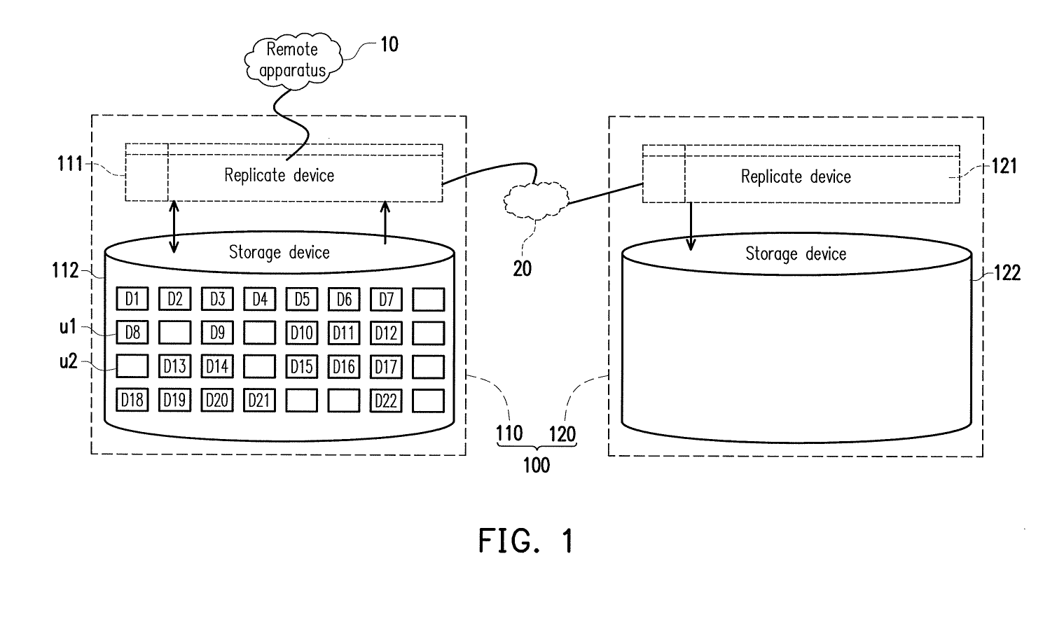

FIG. 1 is a circuit block view illustrating a data synchronization device 100 without redundant data replication according to an embodiment of the invention. The data synchronization device 100 includes a target storage apparatus 110 and a backup storage apparatus 120. The target storage apparatus 110 provides services to a remote apparatus 10 through a communication network. For example, the target storage apparatus 110 may serve as a network attached storage (NAS) server or other servers of the remote apparatus 10. However, it should be understood that the invention is not limited thereto.

The target storage apparatus 110 at least includes a replicate device 111 and a storage device 112. The replicate device 111 of the target storage apparatus 110 is coupled to the storage device 112 of the target storage apparatus 110. Based on the design requirement, the storage device 112 may include a hard drive, a solid state drive, a hybrid drive, or other non-transitory computer readable media. Based on a request of the remote apparatus 10, the replicate device 111 may access the storage device 112 to provide the services to the remote apparatus 10.

In the embodiment shown in FIG. 1, a plurality of blocks (e.g., blocks u1 and u2 as well as rest of the blocks) in the storage device 112 represent a plurality of data blocks in the storage device 112. Some of the data blocks of the storage device 112 respectively store valid data D1, D2, D3, D4, D5, D6, D7, D8, D9, D10, D11, D12, D13, D14, D15, D16, D17, D18, D19, D20, D21, and D22 (e.g., the data block u1 already stores the valid data D8), while other data blocks (e.g., the data block u2) of the storage device 112 does not store valid data. A data block that does not store valid data is also referred to as unallocated space.

The backup storage apparatus 120 is coupled to the target storage apparatus 110 through a communication network 20 (e.g. an Ethernet network or other networks). The backup storage apparatus 120 at least includes a replicate device 121 and a storage device 122. The replicate device 121 of the backup storage apparatus 120 is coupled to the storage device 122 of the backup storage apparatus 120. Based on the design requirement, the storage device 122 may include a hard drive, a solid state drive, a hybrid drive, or other non-transitory computer readable media. The replicate device 121 of the backup storage apparatus 120 may be connected with the replicate device 111 of the target storage apparatus 110 through the communication network 20. To avoid unexpected data loss of the storage device 112, the replicate device 111 and the replicate device 121 may replicate/synchronize data stored in the storage device 112 to the storage device 122 of the backup storage apparatus 120.

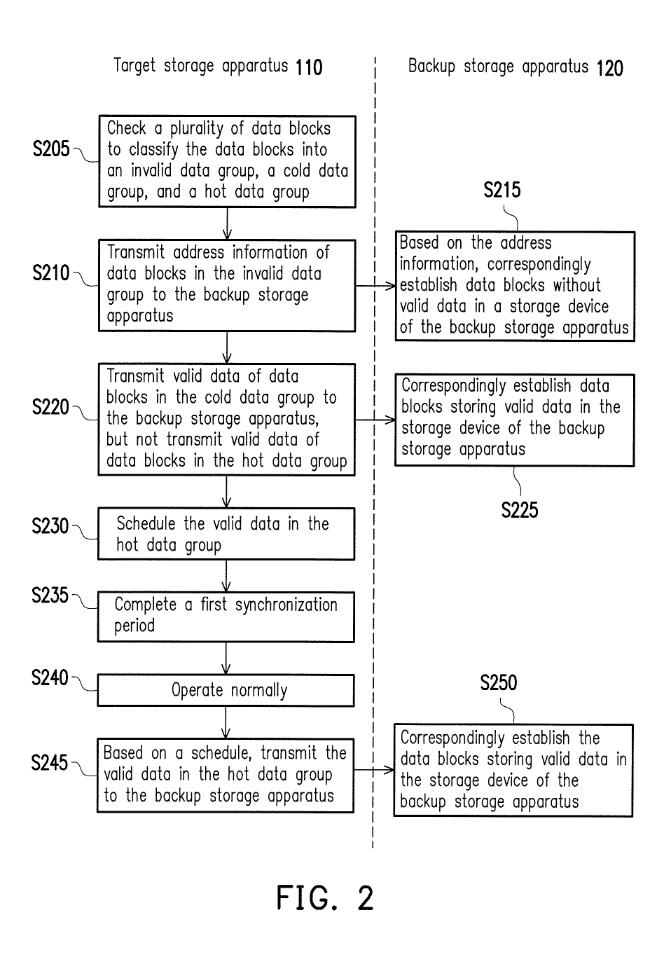

FIG. 2 is a flowchart illustrating a data synchronization method without redundant data replication according to an embodiment of the invention. Referring to FIGS. 1 and 2, at Step S205, the replicate device 111 of the target storage apparatus 110 may check the data blocks of the storage device 112 of the target storage apparatus 110, so as to classify the data blocks at least into an invalid data group, a cold data (or seldom accessed data) group and a hot data (or frequently accessed data) group. For example, the replicate device 111 of the target storage apparatus 110 may check update statuses of a plurality of valid data stored in the storage device 112 of the target storage apparatus 110 at Step S205. Based on the update statuses of the valid data, the replicate device 111 may classify the valid data at least into the cold data group and the hot data group at Step S205.

In some embodiments, the replicate device 111 of the target storage apparatus 110 may check the updated statuses of all the data blocks of the storage device 112 of the target storage apparatus 110 at Step S205, so as to obtain a statistical result. In a process where the replicate device 111 performs a service-based access to the storage device 112 based on a request of the remote apparatus 10, the replicate device 111 may check the service-based access with respect to each data block of the storage device 112 in the background, so as to obtain the statistical result. In other embodiments, the update statuses of the data blocks of the storage device 112 may be checked by another calculating device (not shown), and the another calculating device may provide the statistical result about the update statuses of the data blocks to the replicate device 111.

At Step S205, the replicate device 111 of the target storage apparatus 110 may be informed of which data blocks of the data blocks in the storage device 112 of the target storage apparatus 110 does not store valid data based on the statistical result. The replicate device 111 may mark the data blocks without valid data in the storage device 112 in a bitmap table. In addition, the replicate device 111 of the target storage apparatus 110 may classify the data blocks of the storage device 112 of the target storage apparatus 110 at least into the cold data group and the hot data group based on the statistical result. The replicate device 111 of the target storage apparatus 110 may mark the data blocks in the cold data group in a statistical table and mark the data blocks in the hot data group also in the statistical table.

For example, the statistical result may indicate that the valid data D1, D6, D8, D9, D11, D13, D14, D18, and D20 shown in FIG. 1 are hot data, and the valid data D2 to D5, D7, D10, D12, D15 to D17, D19, D21, and D22 shown in FIG. 1 are cold data. Thus, the data blocks storing the valid data D1, D6, D8, D9, D11, D13, D14, D18, and D20 are classified as the hot data group, whereas the data blocks storing the valid data D2 to D5, D7, D10, D12, D15 to D17, D19, D21, and D22 are classified as the cold data group.

During a first synchronization period, the replicate device 121 of the backup storage apparatus 120 correspondingly establishes data blocks without valid data in a plurality of data blocks in the storage device 122 of the backup storage apparatus 120 based on address information of at least one data block without valid data in the data blocks of the storage device 112 of the target storage apparatus 110. Specifically, at Step S210, the replicate device 111 of the target storage apparatus 110 transmits the address information of the data blocks without valid data (or unallocated space) in the storage device 112 to the backup storage apparatus 120, but does not transmit contents (invalid data) of the data blocks to the backup storage apparatus 120. At Step S215, the replicate device 121 of the backup storage apparatus 120 correspondingly establishes the data blocks without valid data (or blank data blocks) in the storage device 122.

For example, the replicate device 111 of the target storage apparatus 110 may check the data blocks of the storage device 112 of the target storage apparatus 110, so as to obtain the address information of the data blocks without valid data in the data blocks. However, it should be understood that the invention is not limited thereto. At Step S210, the replicate device 111 of the target storage apparatus 110 may transmit a packet without payload to the backup storage apparatus 120. In addition, the packet without payload carries the address information of the data blocks without valid data of the storage device 112. Based on the address information carried by the packet without payload, the replicate device 121 of the backup storage apparatus 120 may correspondingly establish the data blocks without valid data (or blank data blocks) in the data blocks of the storage device 122 of the backup storage apparatus 120 at Step S215.

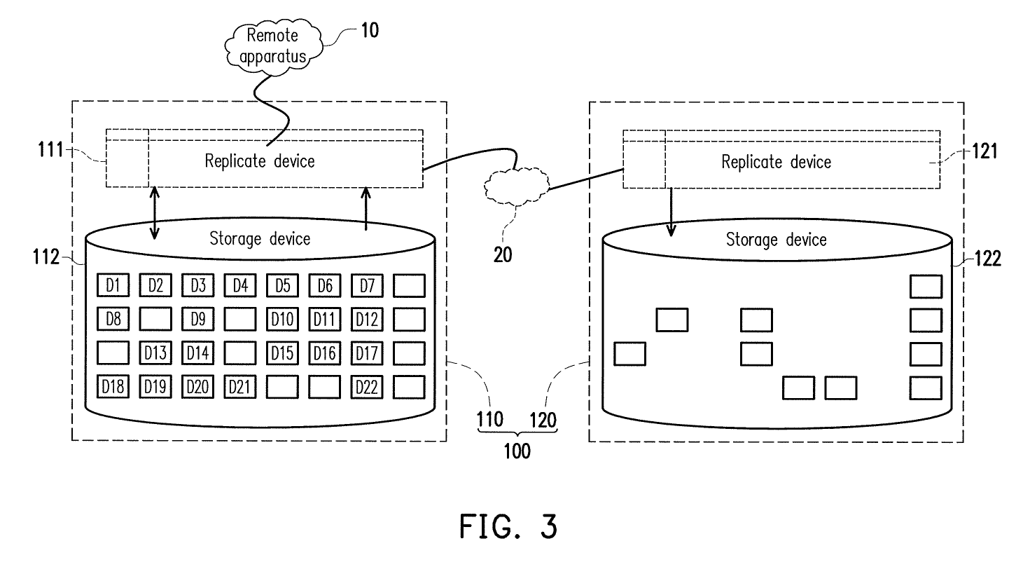

FIG. 3 is a schematic view illustrating a scenario where the target storage apparatus 110 transmits the packet without payload to the backup storage apparatus 120 when Steps S210 and S215 in FIG. 2 are performed. Referring to FIGS. 2 and 3, at Step S210, the replicate device 111 of the target storage apparatus 110 may check the data blocks of the storage device 112 to obtain the address information of the data blocks without valid data. At Step S210, the replicate device 111 of the target storage apparatus 110 may transmits the packet without payload to the backup storage apparatus 120 through the communication network 20. The packet carries the address information of the data blocks without valid data in the storage device 112, but does not carry the contents (data) of the data blocks. Based on the address information carried by the packet without payload, the replicate device 121 of the backup storage apparatus 120 may correspondingly establish the data blocks without valid data (or blank data blocks) in the data blocks of the storage device 122 at Step S215. In the embodiment shown in FIG. 3, the blocks shown in the storage device 122 indicate that the replicate device 121 establishes the corresponding blank data blocks (i.e., data blocks without valid data) in the storage device 122 at Step S215 based on the address information in the packet without payload transmitted by the target storage apparatus 110. In the first data replication/synchronization period, since the target storage apparatus 110 only transmits the address information of the data blocks with invalid data to the backup storage apparatus 120 without transmitting the invalid data to the backup storage apparatus 120, the target storage apparatus 110 saves the redundant replication of the invalid data to the backup storage apparatus 120 during the first synchronization period. Therefore, an efficiency during the first data replication/synchronization period is improved.

During the first synchronization period, the replicate device 121 of the backup storage apparatus 120 synchronizes the valid data in the cold data group from the storage device 112 of the target storage apparatus 110 to the storage device 122 of the backup storage apparatus 120, and does not synchronize the valid data in the hot data group from the storage device 112 of the target storage apparatus 110 to the storage device 122 of the backup storage apparatus 120. Specifically, at Step S220 shown in FIG. 2, the replicate device 111 of the target storage apparatus 110 may transmit the valid data in the cold data group of the storage device 112 to the backup storage apparatus 120, but does not transmit the valid data in the hot data group to the backup storage apparatus 120 in the first synchronization period. At Step S225 shown in FIG. 2, the replicate device 121 of the backup storage apparatus 120 establishes the data blocks storing valid data in the storage device 122 of the backup storage apparatus 120 during the first synchronization process, so as to store the valid data in the cold data group from the target storage apparatus 110.

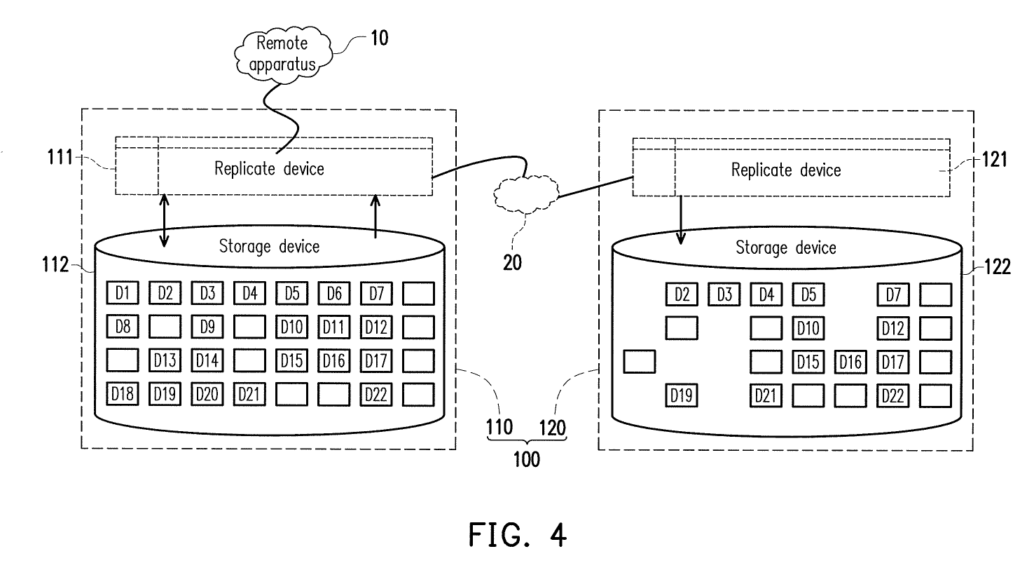

FIG. 4 is a schematic view illustrating a scenario where the target storage apparatus 110 transmits the valid data of the cold data group to the backup storage apparatus 120 when Steps S220 and S225 in FIG. 2 are performed. Referring to FIGS. 2 and 4, at Step S220, the replicate device 111 of the target storage apparatus 110 may transmit the valid data of the data blocks in the cold data group in the storage device 112 to the backup storage apparatus 120 via the communication network 20, but does not transmit the valid data of the data blocks in the hot data group to the backup storage apparatus 120. For example, assuming that the valid data D1, D6, D8, D9, D11, D13, D14, D18, and D20 shown in FIG. 4 are hot data, and the valid data D2 to D5, D7, D10, D12, D15 to D17, D19, D21, and D22 shown in FIG. 4 are cold data, the replicate device 111 may transmit the valid data D2 to D5, D7, D10, D12, D15 to D17, D19, D21, and D22 of the data blocks in the cold data group in the storage device 112 to the backup storage apparatus 120 through the communication network 20 at Step S220, and the valid data D1, D6, D8, D9, D11, D13, D14, D18, and D20 of the data blocks in the hot data group in the storage device 112 are not transmitted to the backup storage apparatus 120. The replicate device 121 of the backup storage apparatus 120 may synchronize the valid data D2 to D5, D7, D10, D12, D15 to D17, D19, D21, and D22 in the cold data group from the storage device 112 of the target storage apparatus 110 to the storage device 122 of the backup storage apparatus 120 at Step S225.

Here, the term “hot data” refers to data that are frequently accessed/modified recently. If the hot data in one data block of the target storage apparatus 110 are replicated to the backup storage apparatus 120 during the first data replication/synchronization period, the data may be redundantly replicated because the hot data in the data block need to be synchronized/replicated to the storage device 120 again once the hot data of the data block of the target storage apparatus 110 are modified again. In the first data replication/synchronization period, since the target storage apparatus 110 only transmits the cold data to the backup storage apparatus 120 without transmitting the hot data to the backup storage apparatus 120, the target storage apparatus 110 saves the redundant replication of the hot data to the backup storage apparatus 120 during the first synchronization period. Therefore, the efficiency during the first data replication/synchronization period is improved.

At Step S230 shown in FIG. 2, the replicate device 111 of the target storage apparatus 110 may schedule the valid data in the hot data group in the first synchronization period, so as to arrange to synchronize the valid data in the hot data group from the storage device 112 of the target storage apparatus 110 to the storage device 122 of the backup storage apparatus 122 in a synchronization time after the first synchronization period ends. After the first synchronization period ends (Step S235), the target storage apparatus 110 operates normally (Step S240) to provide services to the remote apparatus 10. In a synchronization time during the normal operation period, the replicate device 111 may synchronize the valid data in the hot data group from the storage device 112 of the target storage apparatus 110 to the storage device 122 of the backup storage apparatus 120 based on a schedule. Specifically, in Step S245 shown in FIG. 2, the replicate device 111 of the target storage apparatus 110 may transmit the valid data in the hot data group in the storage device 112 to the backup storage apparatus 120 based on the schedule. At Step S250 shown in FIG. 2, the replicate device 121 of the backup storage apparatus 120 correspondingly establishes the data blocks storing valid data in the storage device 122 of the backup storage apparatus 120, so as to store the valid data of the hot data group from the target storage apparatus 110.

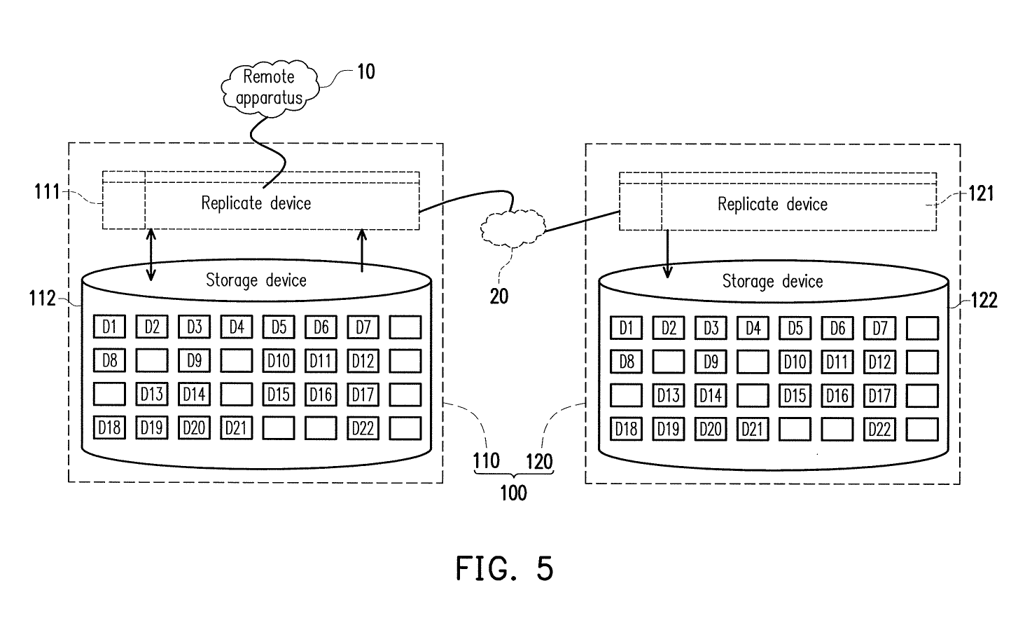

FIG. 5 is a schematic view illustrating a scenario where the target storage apparatus 110 transmits the valid data of the hot data group to the backup storage apparatus 120 when Steps S245 and S250 of FIG. 2 are performed. Referring to FIGS. 2 and 5, the replicate device 111 of the target storage apparatus 110 may transmit the valid data of the data blocks in the hot data group of the storage device 112 to the backup storage apparatus 120 through the communication network 20. For example, assuming that the valid data D1, D6, D8, D9, D11, D13, D14, D18, and D20 shown in FIG. 5 are hot data, the replicate device 111 may transmit the valid data D1, D6, D8, D9, D11, D13, D14, D18, and D20 in the data blocks of the hot data group in the storage device 112 to the backup storage apparatus 120 through the communication network 20 at Step S220. The replicate device 121 of the backup storage apparatus 120 may synchronize the valid data D1, D6, D8, D9, D11, D13, D14, D18, and D20 in the hot data group from the storage device 112 of the target storage apparatus 110 to the storage device 122 of the backup storage apparatus 120 at Step S250.

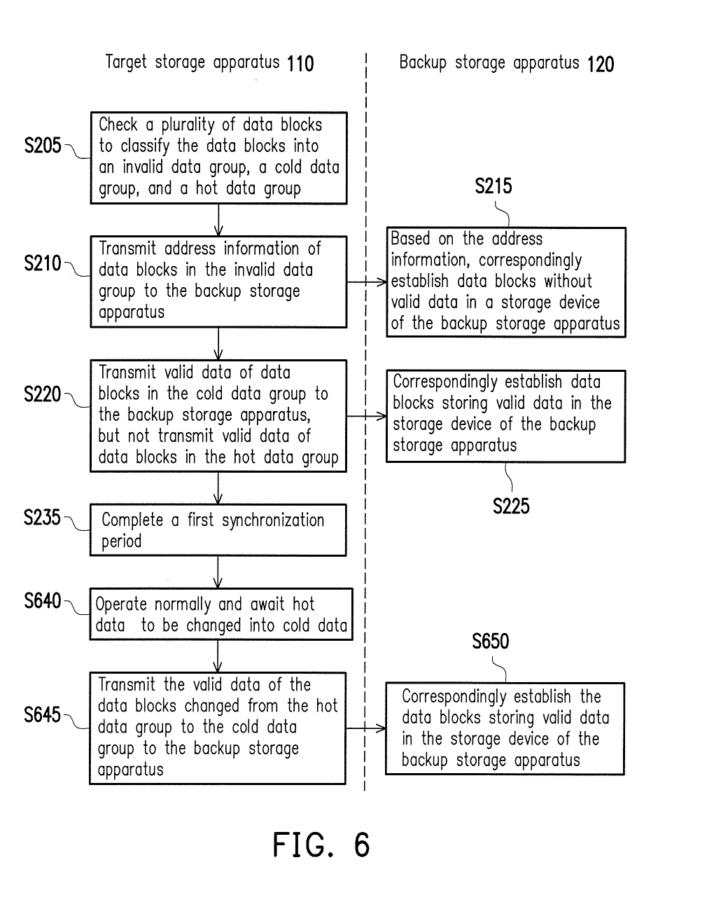

FIG. 6 is a flowchart illustrating a data synchronization method without redundant data replication according to another embodiment of the invention. Steps S205, S210, S215, S220, S225, and S235 shown in FIG. 6 may follow the descriptions in connection with Steps S205, S210, S215, S220, S225, and S235 shown in FIG. 2. Thus, details in these regards will not be repeated in the following. In the embodiment shown in FIG. 6, after the valid data of the cold data group have been synchronized from the storage device 112 of the target storage apparatus 110 to the storage device 122 of the backup storage apparatus 120 (Step S220), the first synchronization period is completed (Step S235). After the first synchronization period is completed, the target storage apparatus 110 operates normally (Step S640), and awaits the valid data originally in the hot data group to be changed to the cold data group. The replicate device 111 of the target storage apparatus 110 may synchronize the valid data changed from the hot data group to the cold data group from the storage device 112 of the target storage apparatus 110 to the storage device 122 of the backup storage apparatus 120. Specifically, at Step S645 shown in FIG. 6, the replicate device 111 of the target storage apparatus 110 may transmit the valid data changed from the hot data group to the cold data group from the storage device 112 to the backup storage apparatus 120. At Step S650 shown in FIG. 6, the replicate device 121 of the backup storage apparatus 120 correspondingly establishes the data blocks storing valid data in the storage device 122, so as to store the valid data (i.e., the valid data changed from the hot data group to the cold data group) from the target storage apparatus 110.

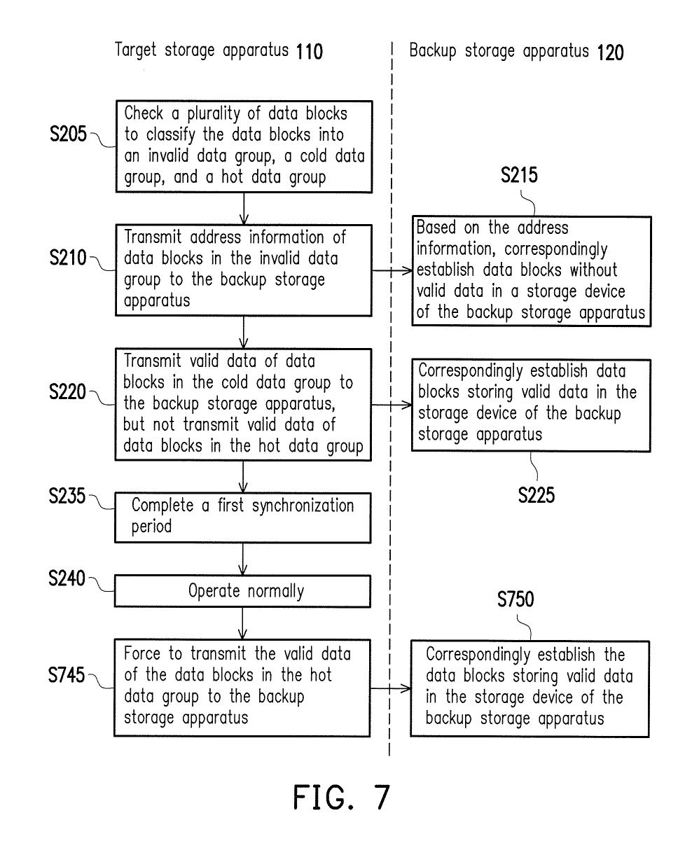

FIG. 7 is a flowchart illustrating a data synchronization method without redundant data replication according to still another embodiment of the invention. Steps S205, S210, S215, S220, S225, S235, and S240 shown in FIG. 7 may follow the descriptions in connection with Steps S205, S210, S215, S220, S225, S235, and S240 shown in FIG. 2. Thus, details in these regards will not be repeated in the following. In the embodiment shown in FIG. 7, after the valid data of the cold data group have been synchronized from the storage device 112 of the target storage apparatus 110 to the storage device 122 of the backup storage apparatus 120 (Step S220), the first synchronization period is completed (Step S235). After the first synchronization period is completed, the target storage apparatus 110 operates normally (Step S240). After the first synchronization period is completed, the replicate device 111 of the target storage apparatus 110 may force the valid data in the hot data group to be synchronized from the storage device 112 of the target storage apparatus 110 to the storage device 122 of the backup storage apparatus 120. Specifically, at Step S745 shown in FIG. 7, the replicate device 111 of the target storage apparatus 110 may force the valid data in the hot data group to be transmitted from the storage device 112 to the backup storage apparatus 120. At Step S750 shown in FIG. 7, the replicate device 121 of the backup storage apparatus 120 correspondingly establishes the data blocks storing valid data in the storage device 122, so as to store the hot data from the target storage apparatus 110.

It should be noted that, in different scenarios of application, relevant functions of the replicate device 111 and/or the replicate device 121 may be implemented as software, firmware, or hardware using conventional programming languages (e.g., C or C++), hardware description languages (e.g., Verilog HDL or VHDL), or other suitable programming languages. The software (or firmware) capable of carrying out the relevant functions may be arranged in any conventional computer-accessible media, such as magnetic tapes, semiconductor memories, magnetic disks, compact disks (e.g., CD-ROM or DVD-ROM). The software (firmware) may be transmitted via the Internet, wired communication, wireless communication, or other communication media. The software (or firmware) may be stored in the computer-accessible media, so that the processor of the computer may access/execute programming codes of the software (or firmware). In addition, the device and method according to the embodiments of the invention may be carried out through combination of hardware and software.

In view of the foregoing, the data synchronization method and device without redundant data replication according to the embodiments of the invention classify the valid data stored in the target storage apparatus 110 at least into the cold data group and the hot data group. During the first synchronization period, the valid data in the cold data group in the target storage apparatus 110 are synchronized to the backup storage apparatus 120, and the valid data in the hot data group in the target storage apparatus 110 are not synchronized to the backup storage apparatus 120. Moreover, during the first synchronization period, the target storage apparatus 110 only transmits the address information of the data blocks of the invalid data to the backup storage apparatus 120, and does not transmit the invalid data to the backup storage apparatus 120. For the blocks without valid data, the target storage apparatus 110 may transmit the packet without payload having the address information of the data blocks without valid data to the backup storage apparatus 120. Thus, the data synchronization method and device without redundant data replication according to the embodiments of the invention are able to save the redundant data replication to the backup storage apparatus 120 during the first synchronization period, so as to improve the efficiency of the first synchronization period.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data synchronization method without redundant data replication, adapted to synchronize a plurality of valid data stored in a target storage apparatus to a backup storage apparatus at the same time when providing real-time data access service, the data synchronization method comprising:
checking update statuses of the valid data stored in the target storage apparatus;
classifying the valid data at least into a cold data group and a hot data group based on the update statuses of the valid data;
during a first synchronization period, correspondingly establishing data blocks without valid data in a plurality of data blocks of a storage device of the backup storage apparatus based on address information of at least one data block without valid data in a plurality of data blocks of a storage device of the target storage apparatus; and
during the first synchronization period, synchronizing the valid data in the cold data group from the storage device of the target storage apparatus to the storage device of the backup storage apparatus, and not synchronizing the valid data in the hot data group from the storage device of the target storage apparatus to the storage device of the backup storage apparatus.

2. The data synchronization method as claimed in claim 1, wherein the step of checking the update statuses of the valid data stored in the target storage apparatus comprises:
checking update statuses of the data blocks of the storage device of the target storage apparatus so as to obtain a statistical result;
marking data blocks without valid data in the data blocks of the storage device of the target storage apparatus in a bitmap table based on the statistical result;
classifying the data blocks of the storage device of the target storage apparatus at least into the cold data group and the hot data group based on the statistical result; and
marking the data blocks in the cold data group in a statistical table and marking the data blocks in the hot data group in the statistical table.

3. The data synchronization method as claimed in claim 1, wherein the step of correspondingly establishing the data blocks without valid data in the data blocks of the storage device of the backup storage apparatus comprises:
checking the data blocks of the storage device of the target storage apparatus by using a replicate device of the target storage apparatus, so as to obtain the address information of the data blocks without valid data in the data blocks of the storage device of the target storage apparatus;
transmitting a packet without payload to the backup storage apparatus by using the replicate device of the target storage apparatus, wherein the packet without payload carries the address information of the data blocks without valid data; and
correspondingly establishing the data blocks without valid data in the data blocks of the storage device of the backup storage apparatus by using a replicate device of the backup storage apparatus based on the address information of the data blocks without valid data carried by the packet without payload.

4. The data synchronization method as claimed in claim 1, further comprising:
during the first synchronization period, scheduling the valid data of the hot data group, so as to arrange to synchronize the valid data in the hot data group from the storage device of the target storage apparatus to the storage device of the backup storage apparatus at a synchronization time after the first synchronization period is completed.

5. The data synchronization method as claimed in claim 1, further comprising:
completing the first synchronization period after the valid data in the cold data group are synchronized from the storage device of the target storage apparatus to the storage device of the backup storage apparatus;
awaiting the valid data originally in the hot data group to be changed to the cold data group after the first synchronization period is completed; and
synchronizing the valid data changed from the hot data group to the cold data group from the storage device of the target storage apparatus to the storage device of the backup storage apparatus.

6. The data synchronization method as claimed in claim 1, further comprising:
completing the first synchronization period after the valid data in the cold data group are synchronized from the storage device of the target storage apparatus to the storage device of the backup storage apparatus; and
forcing the valid data in the hot data group to be synchronized from the storage device of the target storage apparatus to the storage device of the backup storage apparatus after the first synchronization period is completed.

7. A data synchronization device without redundant data replication, comprising:
a target storage apparatus, comprising a replicate device and a storage device, wherein the replicate device of the target storage apparatus is coupled to the storage device of the target storage apparatus, the replicate device of the target storage apparatus checks update statuses of a plurality of valid data stored in the storage device of the target storage apparatus and classifies the valid data at least into a cold data group and a hot data group based on the update statuses of the valid data; and
a backup storage apparatus, coupled to the target storage apparatus and comprising a replicate device and a storage device, wherein the replicate device of the backup storage apparatus is coupled to the storage device of the backup storage apparatus, the replicate device of the backup storage apparatus correspondingly establishes data blocks without valid data in a plurality of data blocks of the storage device of the backup storage apparatus based on address information of at least one data block without valid data in a plurality of data blocks of the storage device of the target storage apparatus in a first synchronization period, and the replicate device of the backup storage apparatus synchronizes the valid data in the cold data group from the storage device of the target storage apparatus to the storage device of the backup storage apparatus and does not synchronize the valid data in the hot data group from the storage device of the target storage apparatus to the storage device of the backup storage apparatus in the first synchronization period.

8. The data synchronization device as claimed in claim 7, wherein the replicate device of the target storage apparatus checks update statuses of the data blocks of the storage device of the target storage apparatus to obtain a statistical result, the replicate device of the target storage apparatus marks data blocks without valid data in the data blocks of the storage device of the target storage apparatus in a bitmap table based on the statistical result, the replicate device of the target storage apparatus classifies the data blocks of the storage device of the target storage apparatus at least into the cold data group and the hot data group based on the statistical result, and the replicate device of the target storage apparatus marks the data blocks in the cold data group in a statistical table and marks the data blocks in the hot data group in the statistical table.

9. The data synchronization device as claimed in claim 7, wherein the replicate device of the target storage apparatus checks the data blocks of the storage device of the target storage apparatus to obtain address information of data blocks without valid data in the data blocks of the storage device of the target storage apparatus, the replicate device of the target storage apparatus transmits a packet without payload to the backup storage apparatus, and the replicate device of the backup storage apparatus correspondingly establishes data blocks without valid data in the data blocks of the storage device of the backup storage apparatus based on the address information of the data blocks without valid data carried by the packet without payload.

10. The data synchronization device as claimed in claim 7, wherein in the first synchronization period, the replicate device of the target storage apparatus schedules the valid data in the hot data group to arrange to synchronize the valid data in the hot data group from the storage device of the target storage apparatus to the storage device of the backup storage apparatus at a synchronization time after the first synchronization period is completed.

11. The data synchronization device as claimed in claim 7, wherein the first synchronization period is completed after the valid data in the cold data group are synchronized from the storage device of the target storage apparatus to the storage device of the backup storage apparatus, the valid data originally in the hot data group is awaited to be changed to the cold data group after the first synchronization period is completed, and the replicate device of the target storage apparatus synchronizes the valid data changed from the hot data group to the cold data group from the storage device of the target storage apparatus to the storage device of the backup storage apparatus.

12. The data synchronization device as claimed in claim 7, wherein the first synchronization period is completed after the valid data in the cold data group are synchronized from the storage device of the target storage apparatus to the storage device of the backup storage apparatus, and the replicate device of the target storage apparatus forces the valid data in the hot data group to be synchronized from the storage device of the target storage apparatus to the storage device of the backup storage apparatus after the first synchronization period is completed.
